(19) United States
(12) Patent Application Publication
(10) Pub. No.: US 2026/0329041 A1
(43) Pub. Date: Oct. 22, 2026

(54) BEND LIMITER FOR FIBER OPTIC CABLES AND METHOD OF USING SAME

(71) Applicant: CORNING RESEARCH & DEVELOPMENT CORPORATION, CORNING, NY (US)

(72) Inventor: Brandon Duvall Compton, Newton, NC (US)

(21) Appl. No.: 19/468,427

(22) Filed: Feb. 3, 2026

Related U.S. Application Data
(60) Provisional application No. 63/760,374, filed on Feb. 19, 2025.

(51) Int. Cl. G02B 6/44; G02B 6/46

(52) U.S. Cl. CPC G02B 6/4459; G02B 6/4429; G02B 6/44515; G02B 6/47

(57) ABSTRACT

A bend limiter for a fiber optic cable that carries optical fibers includes a base and a cover releasably attachable to the base. The base includes a base body, a central passage extending along the base body that is configured to receive at least a portion of the fiber optic cable therein, and a bend path operatively connected to the central passage that is configured to receive a group of the optical fibers therein. The bend path is configured to route the group of optical fibers away from the central passage and then back to the central passage so that the group of optical fibers exits the bend limiter in an opposite direction from which the group of optical fibers entered the bend limiter.

### PRIORITY CLAIM

This application claims the benefit of priority of U.S. Provisional Patent Application Serial No. 63/760,374 filed on Feb. 19, 2025, the content of which is relied upon and incorporated herein by reference in its entirety.

### TECHNICAL FIELD

This disclosure relates generally to fiber optic cables, and more particularly to a bend limiter for use during installation of fiber optic cables and a method of using the bend limiter to safely redirect optical fibers of the fiber optic cables.

### BACKGROUND

The large amount of data and other information transmitted over the internet has led businesses and other organizations to develop large scale data centers for organizing, processing, storing and/or disseminating large amounts of data. Data centers contain a wide range of network equipment including, for example, servers, networking switches, routers, storage subsystems, and so on. Data centers further include a large amount of cabling and equipment racks to organize and interconnect the network equipment in the data center. Modern data centers may include multi-building campuses having, for example, one primary or main building and a number of auxiliary buildings in close proximity to the main building. All the buildings on the campus may be interconnected by a local fiber optic network.

To manage the interconnectivity of a data center, the network equipment within the buildings on the data center campus is often arranged in structured data halls having a large number of spaced-apart rows of equipment racks. Each of the rows is, in turn, configured to receive a number of equipment racks or cabinets which hold the network equipment. In some data center architectures, at the front of each row, a main patch panel (or intermediate distribution frame) connects high-fiber-count distribution cables from the building’s distribution frame to lower-fiber-count distribution cables that extend to the network equipment. The distribution cables may be supported by overhead trays or baskets that organize and route the fiber optic cables along the row of equipment racks, ensuring clean, efficient cable management. Technicians connect the network equipment held in the various equipment racks in the row to these distribution cables during data center installation, using numerous cables that require organization in each equipment rack.

Technicians may run into unexpected difficulties during data center installation. For example, due to supply chain or other limitations, not all equipment racks or network equipment may be available to be installed at the same time. To avoid undue delay, technicians may continue with installation of the available equipment racks and network equipment but skip the installation of any equipment racks and network equipment that may be unavailable. Thus, in a row of equipment racks in the data center, there may be one or more voids where the designated equipment rack was unavailable for installation. In such a circumstance, it may be desired to (e.g., temporarily) reroute the fiber optic cables in the overhead cable tray that were arranged to connect to the network equipment in the missing equipment rack to network equipment in the neighboring equipment racks. If the adjacent equipment rack that the fiber optic cables are to be rerouted is located “downstream” of the missing equipment rack, then the fiber optic cable can be easily rerouted. However, if the adjacent equipment rack that the fiber optic cables are to be rerouted is located “upstream” of the missing equipment rack, then the fiber optic cables must be folded back on themselves (i.e., make a 180-degree bend) in order to connect those fiber optic cables to network equipment in the adjacent equipment rack. Given the delicate optical fibers within the fiber optic cable, special care must be taken to prevent damage to the optical fibers when folding the fiber optic cables back on themselves when rerouting the fiber optic cables upstream of the missing equipment rack. Despite best efforts, bends in the fiber optic cables increase optical losses in the optical fibers of the cables and, in some cases, damage the optical fibers of the cables such that the fiber optic cables may require replacement.

With this in mind, there is a desire to provide a solution for limiting the bending of fiber optic cables arranged in an overhead cable tray, for example, in the event the fiber optic cables have to be rerouted to network equipment in an upstream equipment rack in a row of equipment racks in a data center or other network environment.

### SUMMARY

Certain exemplary aspects of the invention are set forth below. It should be understood that these aspects are presented merely to provide the reader with a brief summary of certain forms the invention might take and that these aspects are not intended to limit the scope of the invention.

In one aspect of the disclosure, a bend limiter for a fiber optic cable carrying a plurality of optical fibers is disclosed. The bend limiter includes a base and a cover releasably attachable to the base. The base includes a base body, a central passage extending along the base body that is configured to receive at least a portion of the fiber optic cable therein, and a bend path operatively connected to the central passage that is configured to receive a group of the plurality of optical fibers therein. The bend path is configured to route the group of optical fibers away from the central passage and then back to the central passage so that the group of optical fibers exits the bend limiter in an opposite direction from which the group of optical fibers entered the bend limiter.

In one embodiment, the base body may have a first end with a first opening and a second end with a second opening. The central path may extend between the first opening and the second opening, and the bend path may be configured to route the group of optical fibers away from the central passage and then back to the central passage so that the group of optical fibers enters and exits the bend limiter at a same opening of the first opening or the second opening of the bend limiter.

In one embodiment, the group of optical fibers may be configured to exit the central passage and enter into the bend path at a first longitudinal location along the bend path, the group of optical fibers may be configured to exit the bend path and reenter the central passage at a second longitudinal location along the central passage, and the first longitudinal location and the second longitudinal location may be substantially the same.

In one embodiment, the base may further include at least one retention latch located along the bend path, and the at least one retention latch may be configured to releasably secure the group of optical fibers within the bend path. In this embodiment, the base may further include at least one recessed surface arranged proximate to the at least one retention latch, and the at least one recessed surface may be configured to provide space for a user to press the group of optical fibers under the at least one retention latch.

In one embodiment, the bend path may include a minimum bend radius, and the minimum bend radius may be configured to be at least 10 times a diameter of the group of optical fibers, such as approximately 20 times the diameter of the group of optical fibers. This prevents excessive bending of the optical fibers in the group of optical fibers that extend in the bend path, thereby avoiding excessive optical losses and potential damage to the optical fibers.

In one embodiment, the cover may be releasably attachable to the base by a cam latch mechanism configured to prevent separation of the cover from the base when the cam latch mechanism is engaged. In one embodiment, the cam latch mechanism may include at least one shoulder integrally formed with the base and at least one flange integrally formed with the cover. The at least one shoulder and the at least one flange are configured to engage with each other to attach the cover to the base.

In one embodiment the cover may be moveable relative to the base between an opened position and a closed position, such as the cover being rotatable relative to the base between the opened and closed positions. The bend limiter may further include a lock mechanism to resist movement of the cover away from the closed position. This maintains the cover in the closed position until a threshold force is applied to move the cover toward the opened position. In one embodiment, the lock mechanism may include at least one security latch on one of the cover or base, and at least one latch receiver on the other of the cover or base. The at least one security latch and the at least one latch receiver are configured to engage each other to resist movement of the cover away from the closed position.

In one embodiment, the base may further include an alternative bend path configured to route the group of optical fibers away from the central passage and then back to the central passage so that the group of optical fibers exits the bend limiter in a same direction from which the group of optical fibers entered the bend limiter. For example, in one embodiment, the alternative bend path may be configured to route the group of optical fibers away from the central passage and then back to the central passage so that the group of optical fibers enters and exits the bend limiter at different openings of the first opening and the second opening of the bend limiter, i.e., the group of optical fibers comes in one opening and goes out the other opening.

In one embodiment, the base of the bend limiter may be symmetrically arranged about the central passage. In this way, the bend limiter may be attached to the fiber optic cable in multiple orientations. In one embodiment, the fiber optic cable may include a plurality of drop leg cables distributed along a length of the fiber optic cable, and the group of optical fibers in the bend limiter may include one of the plurality of drop leg cables. In one embodiment, the bend limiter may be generally diamond shaped to reduce or prevent the bend limiter from becoming snagged on other fiber optic cables or cable trays in which they are situated.

In one embodiment, the base body may further include at least one anchor point for attaching the bend limiter to the fiber optic cable. For example, the base body of the bend limiter may be connected to a mesh sleeve of the fiber optic cable using one or more securing members (e.g., zip ties). In one embodiment, the base body may include a bend mandrel centrally located in the bend limiter, and the bend path may extend about at least a portion of the bend mandrel.

In another aspect of the disclosure, a fiber optic cable assembly for installation in a fiber optic network is disclosed. The fiber optic cable assembly includes a fiber optic cable carrying a plurality of optical fibers and at least one bend limiter according to the first aspect described above connected to the fiber optic cable.

In one embodiment, the fiber optic cable may include a plurality of drop cables, and the fiber optic cable assembly may include a plurality of bend limiters each being positioned adjacent to one of the plurality of drop cables. In one embodiment, the at least one bend limiter may be preinstalled on the fiber optic cable before installation of the fiber optic cable assembly in the fiber optic network. For example, the at least one bend limiter may be installed in a factory prior to the fiber optic cable assembly being shipped to an installation site.

In another aspect of the disclosure, a method of installing a fiber optic cable in a fiber optic network is disclosed. The fiber optic cable carries a plurality of optical fibers. The method includes providing a bend limiter having a base and a cover releasably attachable to the base. The base includes a central passage, and a bend path operatively connected to the central passage. The method further includes inserting the fiber optic cable in the central passageway of the base of the bend limiter and inserting a group of the plurality of optical fibers along the bend path in the base of the bend limiter such that the group of optical fibers is routed away from the central passage and then back to the central passage so that the group of optical fibers exits the bend limiter in the same direction from which the group of optical fibers entered the bend limiter.

In one embodiment the base may further include at least one anchor point, and the method may further include releasably attaching the at fiber optic cable to the anchor point of the base of the bend limiter.

In one embodiment, the base may further include at least one retention latch located along the bend path, and the method may further include releasably retaining the group of optical fibers within the bend path using the at least one retention latch.

In one embodiment, the cover may be releasably connectable to the base by a cam latch mechanism, and the method may further include releasably connecting the cover and the base by the cam latch mechanism to prevent the cover from separating from the base.

In one embodiment, the cover may be moveable relative to the base between an opened position and a closed position, and the method may further include engaging a lock mechanism to resist movement of the cover away from the closed position.

In one embodiment, the method may further include routing the group of optical fibers exiting the bend limiter to an upstream equipment rack and connecting terminated ends of the group of optical fibers to network equipment in the upstream equipment rack.

In one embodiment, the base of the bend limiter may further include an alternative bend path, and the method may further include removing the group of optical fibers from the bend path in the base of the bend limiter and inserting the group of optical fibers in the alternative bend path such that the group of optical fibers is routed away from the central passage and then back to the central passage so that the group of optical fibers exits the bend limiter in a same direction from which the group of optical fibers entered the bend limiter.

In one embodiment, the method may further include routing the group of optical fibers exiting the bend limiter to another equipment rack and connecting the terminated ends of the group of optical fibers to network equipment in the another equipment rack.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of an embodiment of a data center campus, according to an aspect of the disclosure.

FIG. 2 is a partial perspective view of an embodiment of a data hall of the data center campus of FIG. 1.

FIG. 3 is a schematic view of an embodiment of a row of equipment racks of the data hall of FIG. 2.

FIG. 4 is a schematic view of an embodiment of a fiber optic distribution cable, according to an aspect of the disclosure.

FIG. 5 is a detail, schematic view of a portion of a fiber optic cable assembly of FIG. 4, showing drop leg cables extending from the fiber optic cable assembly.

FIG. 6 is a perspective view of a bend limiter according to one embodiment of the disclosure.

FIG. 7 is an exploded perspective view of the bend limiter of FIG. 6.

FIG. 8 is an alternative exploded perspective view of the bend limiter of FIG. 6.

FIG. 8A is a cross-sectional view of the bend limiter taken along line 8A—8A in FIG. 6.

FIG. 8B is a cross-sectional view of the bend limiter taken along line 8B—8B in FIG. 6.

FIG. 9 is a plan view of a base of the bend limiter of FIG. 6.

FIG. 10 is a bottom view of the base of the bend limiter of FIG. 6.

FIG. 11 is a further plan view of the base of the bend limiter of FIG. 6, showing a distribution cable arranged in the base.

FIG. 12 is a further plan view of the base of the bend limiter of FIG. 6, showing a drop leg cable arranged in a bend path in the base.

FIG. 13 is a further plan view of the base of the bend limiter of FIG. 6, showing the cover arranged atop the base and rotating into a closed position.

FIG. 14 is a further plan view of the base of the bend limiter of FIG. 6, showing the cover arranged atop the base in the closed position

FIG. 15 is a further plan view of the base of the bend limiter of FIG. 6, showing a drop leg cable arranged in an alternative bend path in the base.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure. In general, the description relates to a bend limiter for a fiber optic cable assembly. The disclosed bend limiter provides a prescribed bend path for routing a portion of the fiber optic cable assembly (e.g., a drop leg cable) in an upstream direction. Advantageously, use of the bend limiter when routing fiber optic cable assemblies in overhead cable trays during, for example, installation of a data center allows for an installation technician to reroute the portion of the fiber optic cable assembly (e.g., the drop leg cable) to an upstream equipment rack without significant optical losses and without damaging the delicate optical fibers of the fiber optic cable assembly. As used herein, the “upstream” direction is one that requires the fiber optic cable assembly to be folded back onto itself to reroute the cable back in the direction opposite from which the cable came. Thus, use of the bend limiter provides for greater installation flexibility and reliability. These and other benefits of the disclosure will be described in further detail below.

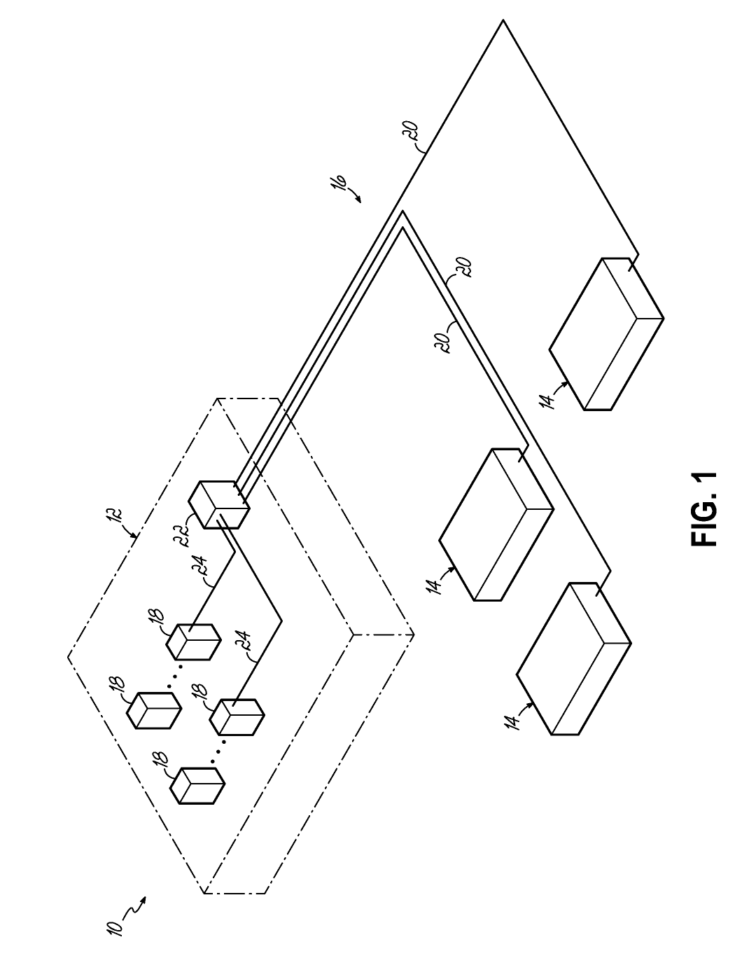

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings 14 are shown, there may be more or fewer depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

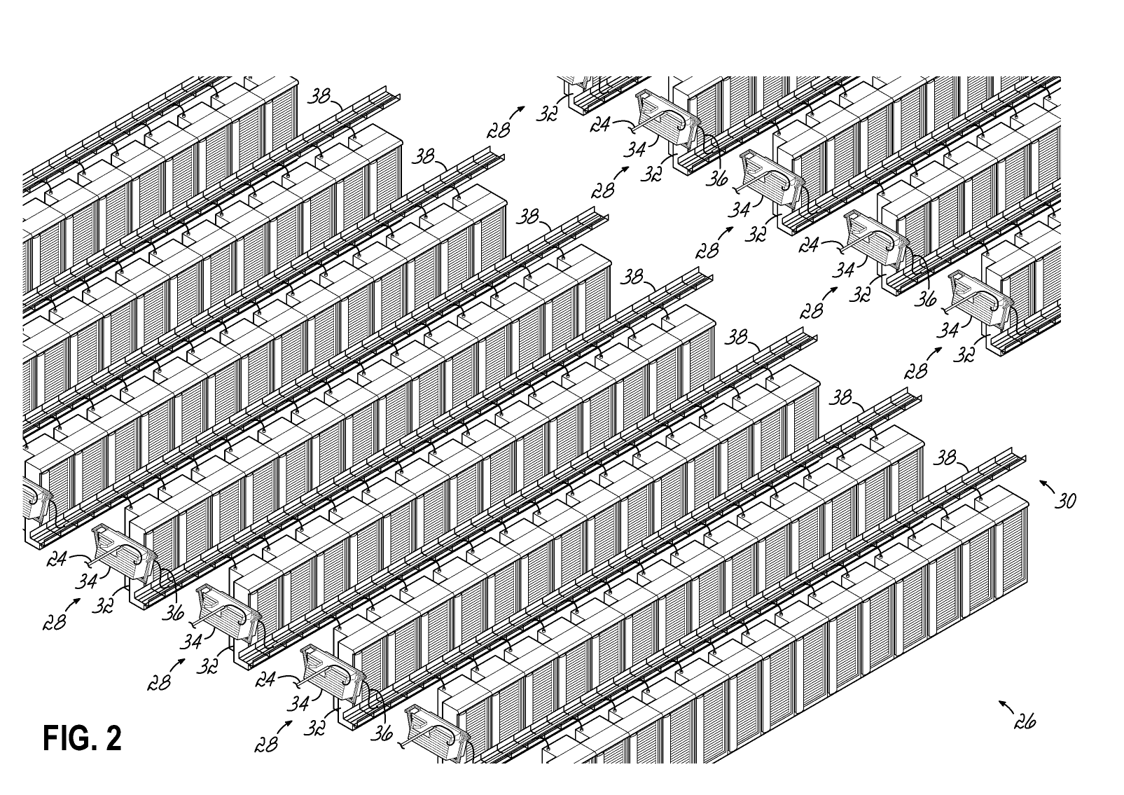

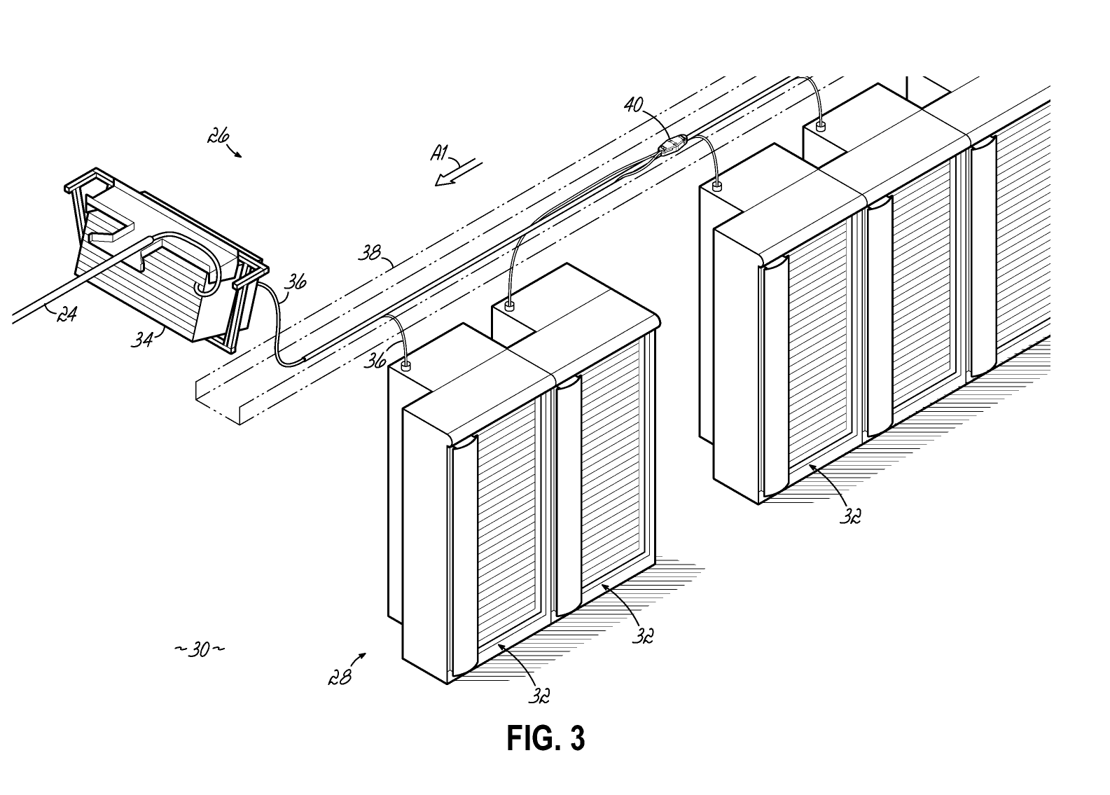

As illustrated in more detail in FIGS. 2 and 3, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, and so on. Each of the rows 28 includes a plurality of equipment racks (or cabinets) 32 generally arranged one next to the other along the row 28. Each of the equipment racks 32 is a vertically arranged framework for holding various network equipment 18 of the data center 10, as is generally known in the telecommunications industry. In one common arrangement, and as further illustrated in FIG. 2, each row 28 may include an intermediate distribution frame 34 at the head end of the row 28 closest to the access pathway 30.

The intermediate distribution frame 34 represents a termination point of at least some of the optical fibers carried by one or more of the indoor cables 24, for example. Although the intermediate distribution frame 34 is shown as being positioned above the row 28, in other embodiments the intermediate distribution frame 34 may be in a cabinet (not shown) at the head end of the row 28 or in the first equipment rack 32 at the head end of the row 28. In yet other embodiments, the intermediate distribution frame 34 may be located within the associated row 28, such as in the middle of the row 28, and be above, below, or within one of the equipment racks 32. In a conventional arrangement, one or more distribution cables 36 are connected to the intermediate distribution frame 34 of a row 28 and routed along a cable tray 38 generally disposed above the row 28. The network equipment 18 in the equipment racks 32 is then optically connected to the one or more distribution cables 36 to provide the interconnectivity of the network equipment 18 (e.g., in equipment racks 32) of the data center 10.

Referring now specifically to FIG. 3, the Figure illustrates one example of a row 28 of equipment racks 32 (containing network equipment 18, for example) within a data center 10. As shown in the Figure, one equipment rack 32 may be missing from the row 28. This is not an uncommon occurrence, particularly during the installation of a data center 10. Due to supply chain or other limitations, not all equipment racks 32 or network equipment 18, for example, may be available to be installed at the same time during data center 10 installation. In such a circumstance, the distribution fiber optic cable 36 (or a portion thereof) arranged in the cable tray 38 above the row 28 of equipment racks 32 may need to be rerouted (temporarily or otherwise) to account for the missing equipment rack 32, for example. When, as shown in FIG. 3, the equipment rack 32 that the distribution fiber optic cable 36 (or portion thereof) is to be rerouted is located in an upstream direction (as shown by arrow A1, for example) of the distribution fiber optic cable 36, the distribution fiber optic cable 36 (or a portion thereof) must be folded back on itself (i.e., make a 180 degree bend). When bending the distribution fiber optic cable 36, special care must be taken to limit bending of the optical fibers in the folded back portion of the distribution fiber optic cable 36 to limit optical losses and to prevent damage to the optical fibers within the distribution fiber optic cable 36.

To this end, as shown in FIG. 3, a bend limiter 40 (described in greater detail below) may be used to limit the bending of the distribution fiber optic cable 36 to a prescribed, acceptable bending radius to limit optical losses and prevent damage to the optical fibers within the distribution fiber optic cable 36, thereby ensuring optical performance. Because the bend limiter 40 may be coupled in the cable tray 38 among a number of distribution cables 36, the bend limiter 40 may advantageously be sized and shaped to minimize snagging. For example, edges and corners of the bend limiter 40 may be rounded so that other distribution cables 36 may be pulled along the cable tray 38 and not get caught or snagged on the bend limiter 40. Similarly, the distribution fiber optic cable 36 including the bend limiter 40 may, itself, be pulled along the cable tray 38 (e.g., if the bend limiter 40 is attached to the distribution fiber optic cable 36 prior to installation of the distribution fiber optic cable 36 in the cable tray 38). Thus, the (substantially diamond) shape, rounded edges, and rounded corners of the bend limiter 40 may also serve to minimize or prevent the bend limiter 40 from getting caught on the cable tray 38 as well.

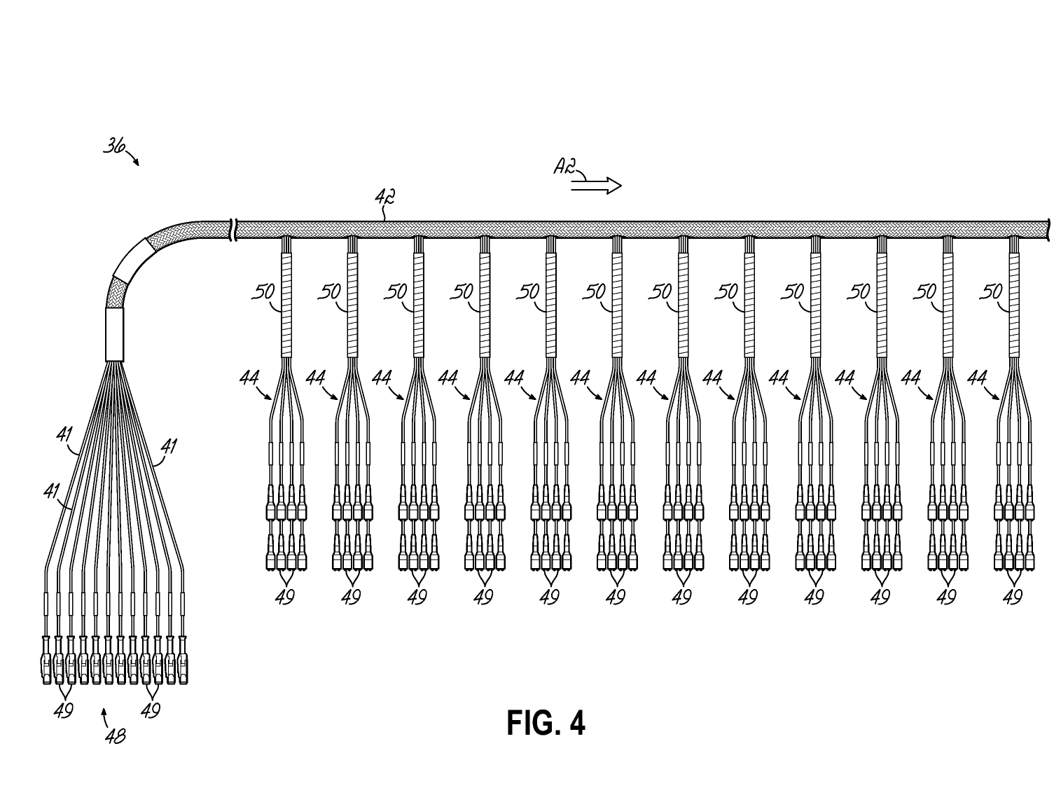

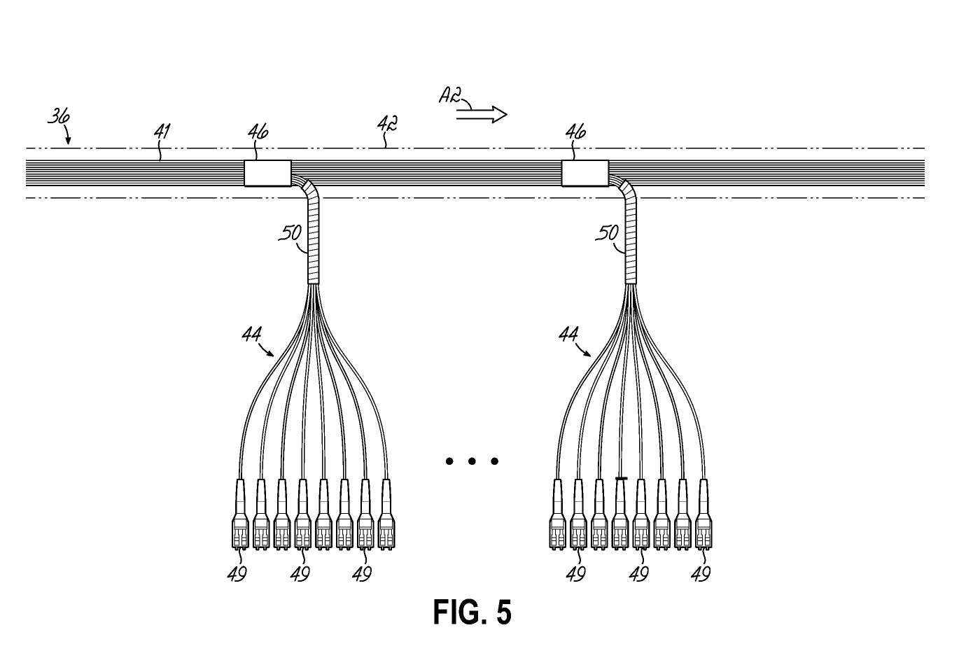

Referring now to FIGS. 4 and 5, the Figures show an exemplary distribution fiber optic cable 36 according to an embodiment of the present disclosure. In the depicted embodiment, the distribution fiber optic cable 36 includes a bundle of fiber optic cable subunits 41 arranged in an outer sleeve 42. In one embodiment, the sleeve 42 may be a split mesh material such as a woven, monofilament mesh with a split that extends the length of the sleeve 42. It should be understood, however, that alternative sleeves 42 may be used. The fiber optic cable subunits 41 may split (e.g., at a furcation 46) into a number of drop leg cables 44. For example, the distribution fiber optic cable 36 may be a bundle of eight fiber optic cable subunits 41 of varying lengths (e.g., depending on the particular needs of the user and arrangement of the data center 10) overlaid on top of each other or intertwined with each other within the sleeve 42. Each cable subunit 41 may include a plurality of optical fibers, such as 24 optical fibers (e.g., for a total of 192 optical fibers), for example, that splits into a plurality of drop leg cables 44, such as, for example, three drop let cables 44. It should be understood that the distribution fiber optic cable 36 could be alternatively arranged. For example, there could be fewer or more than eight fiber optic cable subunits 41 in the distribution fiber optic cable 36. Further, each fiber optic cable subunit 41 may have fewer or more than 24 optical fibers. Additionally, each fiber optic cable subunit 41 could split into fewer or more than three drop leg cables 44.

At the head end 48 of the distribution fiber optic cable 36, the fiber optic cable subunits 41 may be terminated with one or more fiber optic connectors 49, such as MMC connectors. Similarly, the drop leg cables 44 may also be terminated with one or more fiber optic connectors 49, such as MMC connectors. It should be understood that any conventional, or yet to be developed, fiber optic connector or connectorization scheme may be used in accordance with the present disclosure, including, but not limited to simplex or duplex connectors (e.g., LC connectors) and multi-fiber connectors (e.g., MPO connectors). For example, the fiber optic connectors 49 may be an MPO (multi-fiber push on) connector, which is configured for multi-fiber cables including multiple sub-units of optical fibers (e.g., between four to 24 optical fibers). In other embodiments, the fiber optic connectors 49 may be a different type of multi-fiber connector, such as an SN-MT connector commercially available from Senko Advanced Components, Inc. or an MMC connector commercially available from US Conec Ltd. It should be appreciated that the fiber optic connectors 49 at the head end 48 of the distribution fiber optic cable 36 may be the same or different than the fiber optic connectors 49 associated with the drop leg cables 44.

Referring now to FIG. 5, the Figure illustrates further detail of an embodiment of the distribution fiber optic cable 36. More particularly, the Figure shows in greater detail one embodiment of the drop leg cables 44 according to the present disclosure. As noted above, each fiber optic cable subunit 41 of the distribution fiber optic cable 36 splits into a number of drop leg cables 44. Each of the drop leg cables 44 includes a protective wrap 50 to protect the optical fibers within the drop leg cable 44. The protective wrap 50 may be a spiral wrap or similar protective wrap. The drop leg cables 44 exit the sleeve 42 of the distribution fiber optic cable 36 through the split in the sleeve 42 at pre-determined locations (e.g., drop locations) along the length of the distribution fiber optic cable 36. The drop leg cables 44 generally exit the sleeve 42 of the distribution fiber optic cable 36 a distance (in the downstream direction, as shown by arrow A2) from the drop leg cable’s 44 associated furcation 46 from the fiber optic cable subunits 41. For example, the location of the furcation 46 where the drop leg cable 44 splits from the fiber optic cable subunits 41 may be approximately 18 inches from the location where the drop leg cable 44 exits the split in the sleeve 42 of the distribution fiber optic cable 36. It should be understood that alternative spacing is possible. The drop locations at which the drop leg cables 44 exit the sleeve 42 may be chosen to accommodate the particular spacing of a user’s equipment racks 32 in a row 28 of the data center 10, for example. In this way, the distribution fiber optic cable 36 may be customized according to a particular user’s needs. In one embodiment, the bend limiter 40 may be located approximately six to eight inches from the location where the drop leg cable 44 exits the split in the sleeve 42 of the distribution fiber optic cable 36. It should be understood, however that alternative spacing may be possible depending on the particular application.

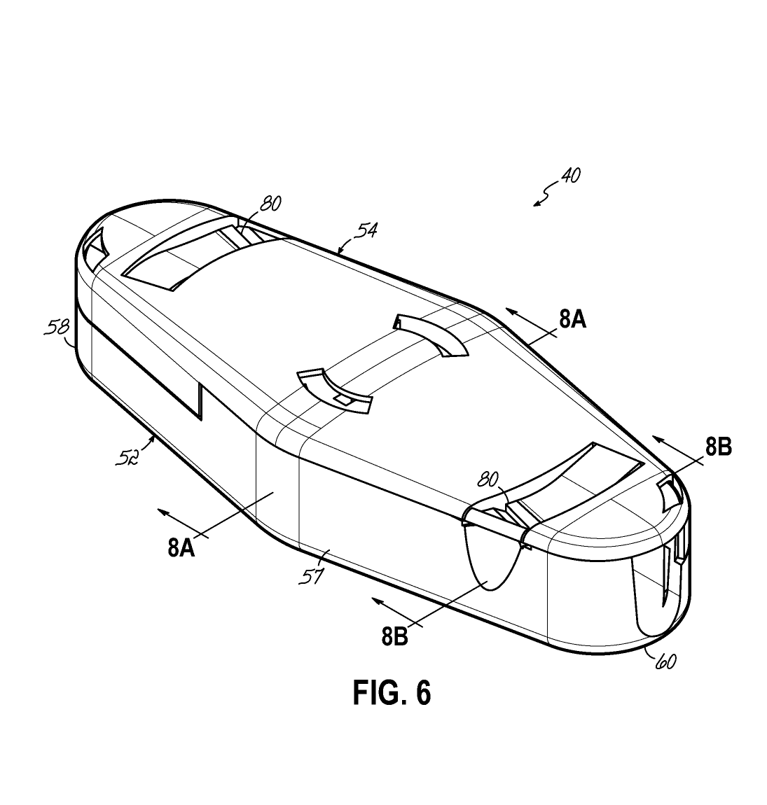

Referring now to FIG. 6, the Figure illustrates the bend limiter 40 according to one embodiment of the present disclosure. In the depicted embodiment, the bend limiter 40 may be substantially diamond-shaped. More particularly, in an exemplary embodiment, the bend limiter 40 may be substantially symmetrical in shape (and in internal arrangement, as will be addressed in greater detail below) such that there is no incorrect orientation that the bend limiter 40 may be installed on the distribution fiber optic cable 36 so long as the “long” axis of the diamond is generally parallel to the axis of the fiber optic cable 36. The symmetry in the bend limiter 40 is relative to a longitudinal axis of the bend limiter 40 generally defined by the axis of the distribution fiber optic cable 36 to which the bend limiter 40 is attached. Such a symmetry provides for greater installation efficiency and reduces installation technician frustration associated with improper attachment orientations. It should be understood that in alternative embodiments, the bend limiter 40 may take on symmetric forms other a than diamond shape. It should also be understood that the bend limiter 40 may have a non-symmetric shape in alternative embodiments. Such alternative embodiments remain within the scope of the present disclosure.

As noted above, the edges and corners of the bend limiter 40 may be rounded to minimize snagging of other distribution cables 36 on the bend limiter 40 in the cable tray 38 and/or to minimize snagging of the bend limiter 40 on the cable tray 38 itself. Additionally, the size of the bend limiter 40 may vary depending on the size of the distribution fiber optic cable 36 to which the bend limiter 40 is to be attached. For example, the bend limiter 40 may come in a variety of sizes to accommodate a variety of sizes (e.g., outer diameters) of distribution fiber optic cables 36. Alternatively, the bend limiter 40 may be available in a single size sufficient to accommodate large outer diameter distribution fiber optic cables 36 (and thus may also be used with smaller outer diameter distribution fiber optic cables 36). In one embodiment, the bend limiter 40 may be formed through additive manufacturing or injection molding, for example. It should be understood, however, that other processes may be used to form the bend limiter 40 or portions thereof and remain within the scope of the present disclosure.

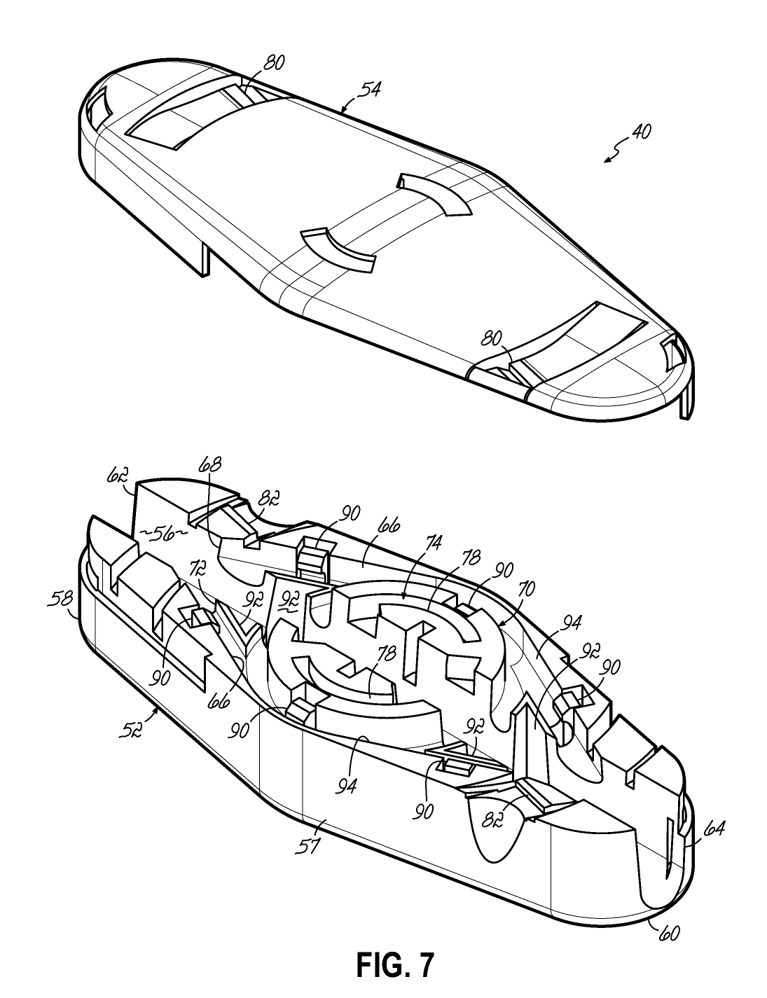

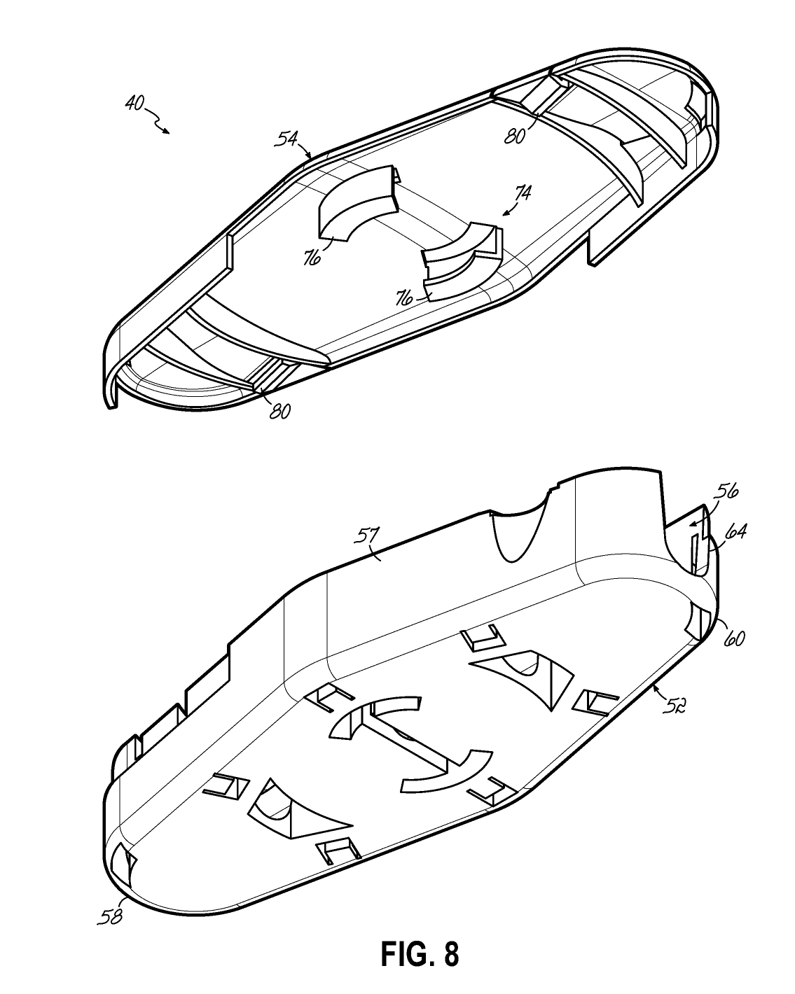

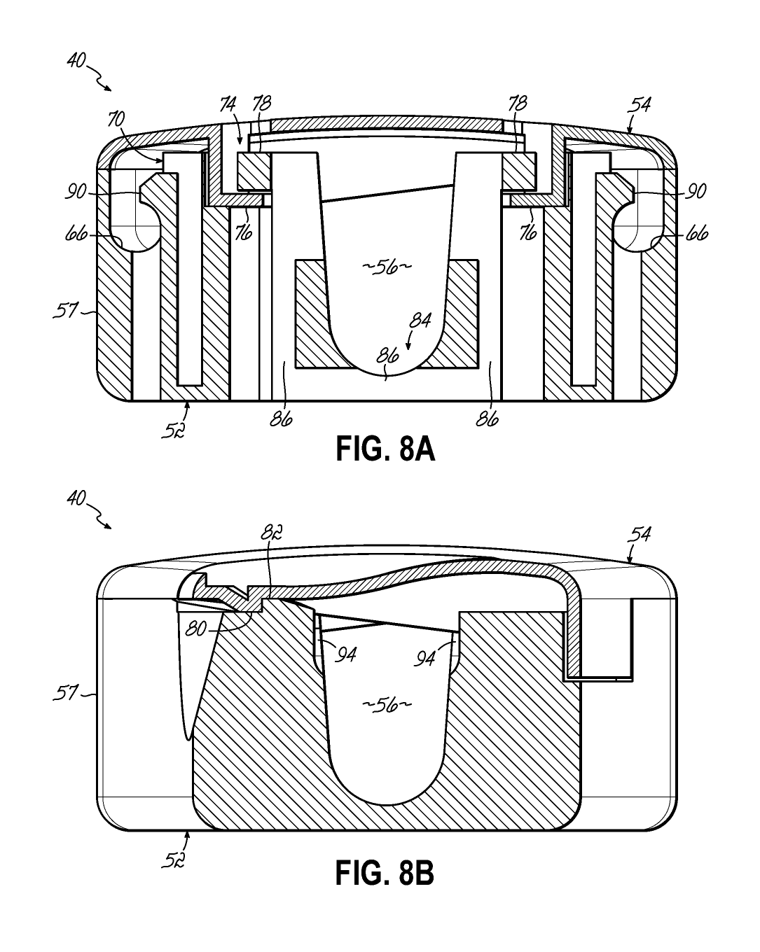

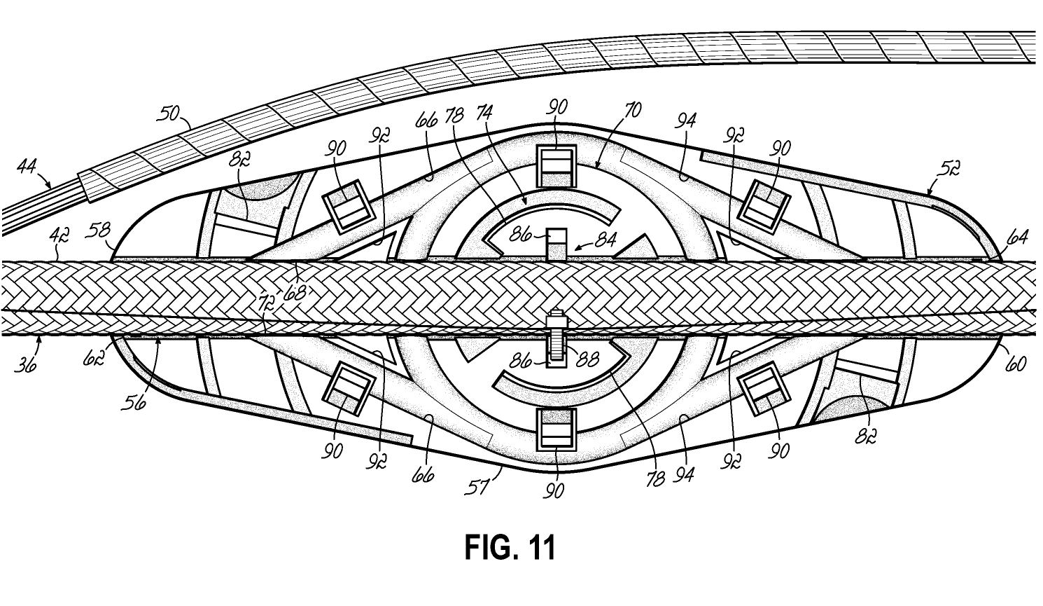

Referring now to FIGS. 7 and 8, the Figures show an exploded view of the bend limiter 40. In the depicted embodiment, the bend limiter 40 includes a base 52 and a cover 54 selectively attachable and separable from each other. As will be described in greater detail below, the cover 54 may be releasably attachable to the base 52 to enclose a portion of the distribution fiber optic cable 36 and drop leg cable 44 within the bend limiter 40. The base 52 includes a central passage 56 that extends longitudinally through a base body 57 of the base 52 from a first end 58 of the base 52 to a second end 60 of the base 52. The central passage 56 includes a first opening 62 at the first end 58 of the base body 57 of the base 52 and a second opening 64 at the second end 60 of the base body 57 of the base 52. The central passage 56 is sized and shaped to receive a portion of the distribution fiber optic cable 36 (FIG. 11) therein.

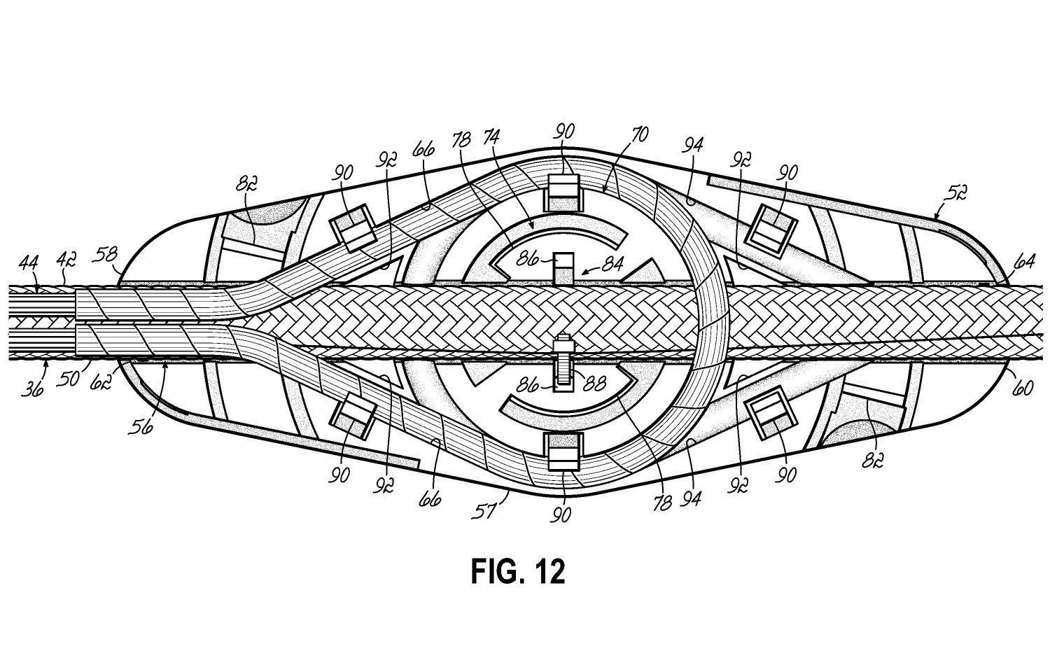

The base 52 further includes a bend path 66 arranged in the base body 57 of the base 52 and operatively connected to (e.g., open to) the central passage 56 at at least two locations. The bend path 66 connects to the central passage 56 at a first aperture 68 at a first position along the length of the central passage 56. The bend path 66 then continues around a bend mandrel 70 (e.g., at least partially wrapping around the bend mandrel 70) and rejoins the central passage 56 at a second aperture 72 at a second location along the length of the central passage 56. In one embodiment, the first location and the second location may be at approximately the same longitudinal location along the central passage 56. In other words, the bend path 66 returns a drop leg cable 44 in the bend path 66 back to the central passage 56 of the bend limiter 40 at approximately the same location in the central passage 56 that the drop leg cable 44 exits the central passage 56 (but, in the opposite direction). The bend path 66 is sized and shaped to receive a portion of the drop leg cable 44 (FIG. 12) therein. As will be described in greater detail below, the bend path 66 limits the bend radius of the drop leg cable 44 such that the drop leg cable 44 bends in an acceptable, pre-determined manner and facilitates the drop leg cable 44 bending 180 degrees back upon the distribution fiber optic cable 36 in the upstream direction of the distribution fiber optic cable 36 without significant optical losses and without damaging the optical fibers.

Referring now to FIG. 8A, the Figure shows a cross-sectional view of the bend limiter 40. More particularly, the Figure illustrates details of a cam latch mechanism 74 that releasably joins the cover 54 to the base 52 depending on the position of the cover 54 relative to the base 52, the cam latch mechanism 74 prevents the cover 54 and base 52 r4om separating from each other (e.g., from being pulled apart). In one embodiment, the cam latch mechanism 74 may include a pair of flanges 76 that extend from the cover 54 in a direction toward the base 52 (e.g., on the underside of the cover 54). Similarly, the cam latch mechanism 74 may further include a pair of shoulders 78 that extend from the base 52 in a direction towards the cover 54 (e.g., on the topside of the base 52). As explained in greater detail below, to releasably join the cover 54 to the base 52, a user (e.g., an installation technician) positions the cover 54 against the base 52 and rotates the cover 54 relative to the base 52 (e.g., from an opened position to a closed position) such that the flanges 76 of the cover 54 become positioned between the shoulders 78 of the base 52 and the remainder of the body 57 of the base 52. The engagement between the flanges 76 and the shoulders 78 prevent the cover 54 from separating from the base 52 until the cover 54 is returned to its opened position relative to the base 52. In the depicted embodiment the cam latch mechanism 74 (e.g., the shoulder(s) 78 and flange(s) 76) may be integrally formed or molded with the base 52 and cover 54, respectively, of the bend limiter 40. It should be understood that in an alternative embodiment the shoulder(s) 78 and the flange(s) 76 could be alternatively formed. In one embodiment, the shoulder 78 may be positioned within the bade mandrel 70 of the base 52.

Referring now to FIG. 8B, the Figure shows a cross-sectional view of the bend limiter 40. More particularly, the Figure illustrates additional details of a lock mechanism, including a security latch 80 and latch receiver 82 that releasably secures the cover 54 of the bend limiter 40 in the closed position relative to the base 52. The lock mechanism resists movement of the cover 54 away from its closed position. In this regard, the cover 54 of the bend limiter 40 may include at least one security latch 80 and the base 52 of the bend limiter 40 may include at least one latch receiver 82. In the depicted embodiment, the cover 54 includes two security latches 80 and the base 52 includes two latch receivers 82. It should be understood that the bend limiter 40 may include fewer or more security latches 80 and/or latch receivers 82. The security latch 80 and the latch receiver 82 engage with one another to releasably secure the bend limiter 40 closed, i.e., restrict movement of the cover 54 away from the closed position relative to the base 52. In this regard, a portion of the security latch 80 engages with a portion of the latch receiver 82 when the cover 54 is rotated relative to the base 52 (i.e., when the cover 54 and base 52 are joined by the cam latch mechanism 74) from the opened position to the closed position. To disengage the security latch 80 from the latch receiver 82 (i.e., when a user desires to remove the cover 54 from the bend limiter 40), a user pulls up on the security latch 80 thereby releasing the portion of the security latch 80 from engagement with the portion of the latch receiver 82 and rotates the cover 54 relative to the base 52 away from the closed position to the open position, where the cover 54 is separate from the base 52, i.e., the cam latch mechanism 74 is disengaged..

The combination of the security latch 80 and the latch receiver 82 prevents or at least reduces the likelihood that the bend limiter 40 will be unintentionally opened when located in the cable tray 38. For example, a distribution fiber optic cable 36 including a bend limiter 40 may be arranged in the cable tray 38 during data center 10 installation. A subsequent distribution fiber optic cable 36 may be added to the cable tray 38 at a later time. When that subsequent distribution fiber optic cable 36 is routed through the cable tray 38 (e.g., by pulling) it may contact the bend limiter 40 attached to the other distribution fiber optic cable 36. The addition of the security latch 80 and latch receiver 82 serves to prevent that contact in the cable tray 38 from unintentionally removing the cover 54 from the base 52 of the bend limiter 40.

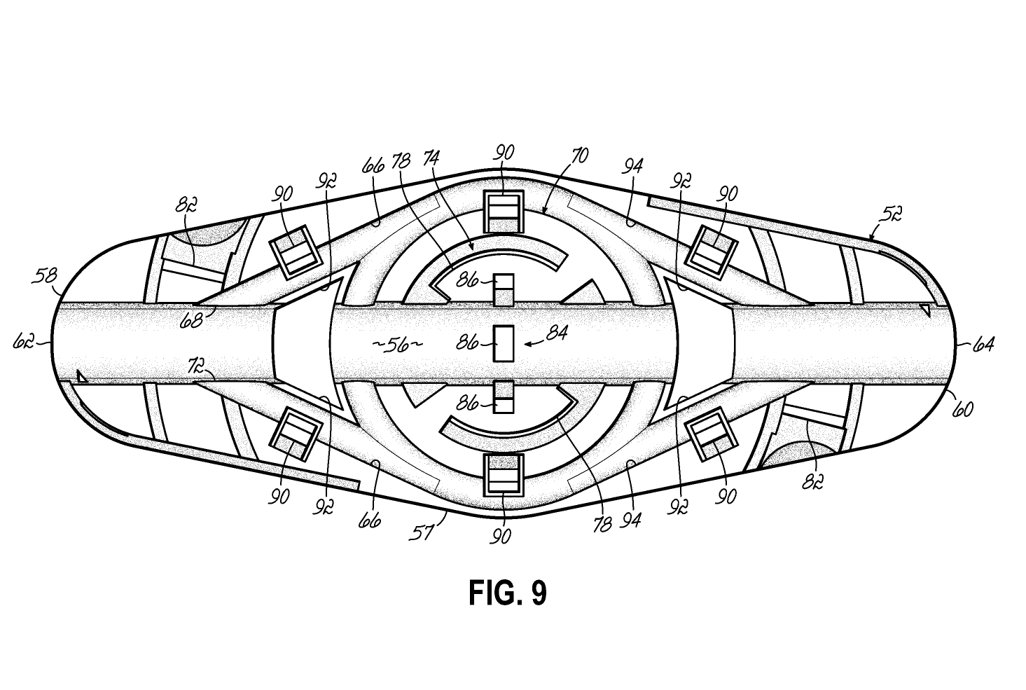

Referring now to FIG. 9, the Figure shows a plan view of the base 52 of the bend limiter 40. In the depicted embodiment, the base 52 includes an anchor point 84 for releasably securing the distribution fiber optic cable 36 to the bend limiter 40. Releasably securing the distribution fiber optic cable 36 to the anchor point 84 of the bend limiter 40 ensures that the distribution fiber optic cable 36 is not unintentionally pulled from the bend limiter 40, which could cause damage to the drop leg cable 44 arranged in the bend path 66, for example. Advantageously, securing the distribution fiber optic cable 36 to the anchor point 84 does not require the use of tools. More particularly, the anchor point 84 may include a number of apertures 86 in or proximate to a central portion of the central passage 56. As explained in greater detail below, the apertures 86 may be configured to receive one or more securing members 88 (FIG. 11) therethrough. It should be understood that in alternative embodiments the anchor point 84 could take on other forms.

Further, in the depicted embodiment, the base 52 may include a number of retention latches 90 located along the bend path 66. The retention latches 90 are configured to releasably secure the drop leg cable 44 within the bend path 66. In other words, the retention latches 90 serve to prevent the drop leg cable 44 from unintentionally being removed from the bend path 66 (e.g., when a technician is installing or removing the cover 54 from the bend limiter 40). Advantageously, securing the drop leg cable 44 within the bend path 66 does not require the use of tools. To releasably secure the drop leg cable 44 in the bend path 66 with the retention latches 90, a technician may press the drop leg cable 44 into the bend path 66 such that the drop leg cable 44 is arranged at least partially between retention latch 90 and the body 57 of the base 52. It should be understood that there could be fewer or more retention latches 90 than are shown in FIG. 9, for example. Further, it should be understood that the retention latches 90 could take on other forms than is shown in the Figures.

With continued reference to FIG. 9, to aid a technician with releasably securing the drop leg cable 44 in the bend path 66 with the retention latches 90, the base 52 may further include a number of recessed surfaces 92. The recessed surfaces 92 may be generally arranged proximate to the retention latches 90 and are configured to provide additional space for a technician’s fingers, for example, to be used to press the drop leg cable 44 into the bend path 66 under at least a portion of the retention latches 90. It should be understood, however, that there could be fewer or more recessed surfaces 92 than are shown in FIG. 9, for example. Further, it should also be understood that the recessed surfaces 92 could take on other forms than is shown in the Figures.

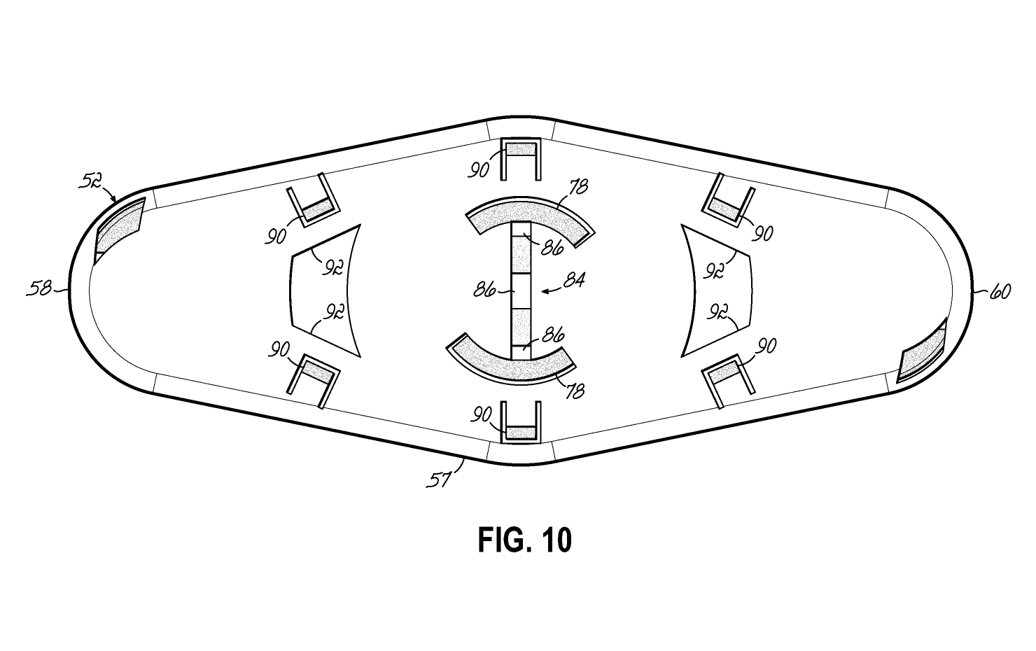

Referring generally to FIGS. 10 and 11, as shown in the depicted embodiment, elements of the base 52 may be (substantially) symmetrically arranged relative to the central passage 56 such that there is no incorrect orientation that the bend limiter 40 may be installed on the distribution fiber optic cable 36. For example, because the base 52 is (substantially) symmetrically arranged, an installation technician may insert the distribution fiber optic cable 36 beginning either at the first end 58 or the second end 60 of the base 52 and still make use of the prescribed bend path 66 of the base 52. This symmetric arrangement provides for greater installation efficiency and reduces installation technician frustration with improper assembly.

Referring now to FIG. 11, the Figure depicts a distribution fiber optic cable 36 inserted into the central passage 56. More particularly, the Figure shows the distribution fiber optic cable 36 releasably secured to the anchor point 84 of the base 52 by a securing member 88. In the depicted embodiment, the securing member 88 may be a zip tie. It should be understood, however, that the securing member 88 could take on other forms. It should also be understood that more than one securing member 88 may be used to releasably secure the distribution fiber optic cable 36 to the anchor point 84 of the bend limiter 40. In the depicted embodiment, the securing member 88 may pass through at least two of the apertures 86 as well as the sleeve 42 of the of the distribution fiber optic cable 36 (but without encircling the optical fibers of the distribution fiber optic cable 36 within the sleeve 42) to secure the distribution fiber optic cable 36 in place. It should be understood that the distribution fiber optic cable 36 may however, be alternatively secured. For example, in an alternative embodiment, the securing member 88 may not pass though the sleeve 42 of the distribution fiber optic cable 36 to secure the distribution fiber optic cable 36. In one embodiment, to accommodate the securing member 88, a portion of the rear of the base 52 may be recessed (FIG. 10) such that the securing member 88 does not protrude from the base 52. This helps to eliminate or reduce potential snagging of the securing member 88 on the cable tray 38 or on other distribution fiber optic cables 36 within the cable tray 38.

Referring now to FIG. 12, the Figure shows a drop leg cable 44 arranged in the bend path 66 of the base 52. In the depicted embodiment, the drop leg cable 44 (in protective wrap 50) enters central passage 56 through the first opening 62, then enters the bend path 66 from the central passage 56, is guided around the bend mandrel 70, exits the bend path 66 back into the central passage 56, and then exits the central passage 56 through the first opening 62. It should be understood that the drop leg cable 44 could alternatively enter and exit the central passage 56 through the second opening 64. The portion of the drop leg cable 44 that is located within the bend path 66 is releasably secured in the bend path 66 by a number of retention latches 90. As noted above, the bend path 66 limits the bend radius of the drop leg cable 44 such that the drop leg cable 44 bends in an acceptable, pre-determined manner. In one embodiment, the bend radius of the bend path 66 may be approximately or at least 10 times a diameter of the drop leg cable 44. For example, if an outer diameter of the drop leg cable 44 is about 1.6 mm, then the bend radius of the bend path 66 may be about 16 mm. In an alternative embodiment, the bend radius of the bend path 66 may be approximately 20 times the diameter of the drop leg cable 44. For example, if the outer diameter of the drop leg cable 44 is about 1.6 mm, then the bend radius of the bend path 66 may be between 30 mm and 36 mm, such as 32 mm. The bend radius of the bend path 66 may depend on the particular configuration of the distribution fiber optic cable 36 or drop leg cable 44. One of ordinary skill in the art understands how to determine a minimum bend reading to avoid significant optical losses and/or avoid damage to the underlying optical fibers.

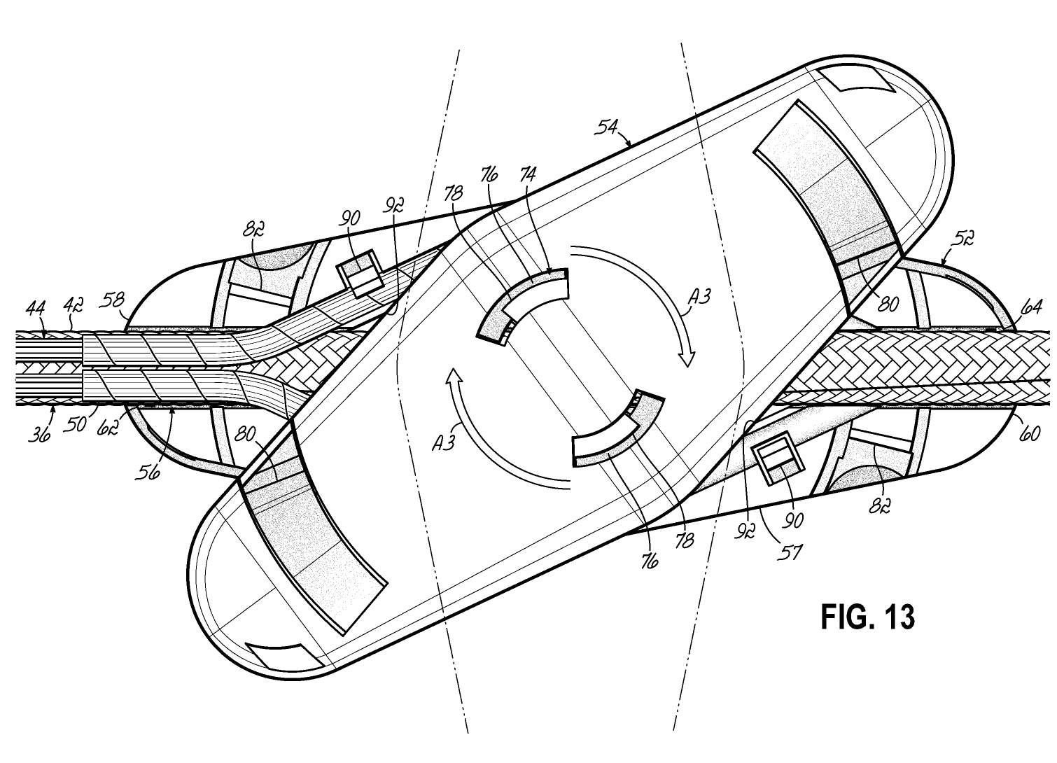

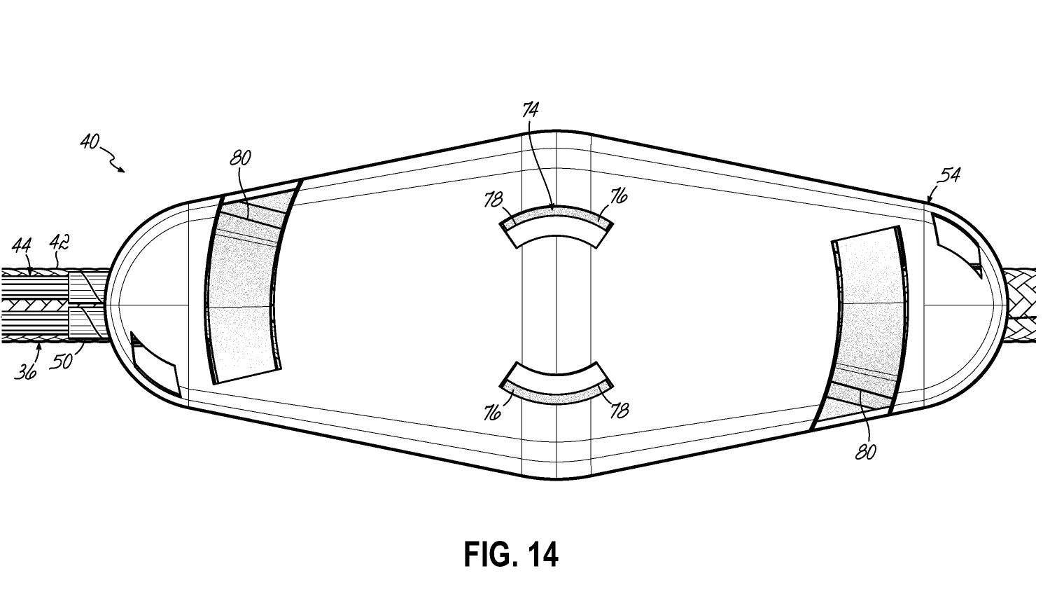

Referring now to FIGS. 13 and 14, the Figures illustrate a process for releasably securing the cover 54 to the base 52 of the bend limiter 40. Advantageously, securing the cover 54 of the bend limiter 40 in the closed position does not require the use of any tools. Similarly, moving the cover 54 of the bend limiter 40 to the opened position also does not require the use of any tools. As shown in phantom, the process begins with the cover 54 in an opened position and arranged such that a longitudinal axis of the cover 54 is transverse to, such as being substantially perpendicular to, a longitudinal axis of the base 52. FIG. 13 shows that as the cover 54 is turned (e.g., clockwise—as shown by arrows A3) from the opened position towards a closed position, the flanges 76 and shoulders 78 of the cam latch mechanism 74 begin to engage with each other. Again, this prevents the cover 54 from separating from the base 52. As the cover 54 continues to be turned (e.g., in the clockwise direction), the security latch(es) 80 and latch receiver(s) 82 begin to engage with each other. This engagement resists movement of the cover 54 away from the closed position. As the cover 54 completes the quarter (i.e., 90 degree) turn (e.g., in the clockwise direction), the cam latch mechanism 74 becomes fully seated and the security latch(es) 80 and latch receiver(s) 82 fully engage with each other. Thus, as shown in FIG. 14, in the depicted embodiment, the cover 54 is secured to the base 52 with a quarter (i.e., 90 degree) turn relative to the base 52 (e.g., in the clockwise direction). The process of removing the cover 54 from the base 52 generally is the reverse of what is described above, with the added step of first disengaging the security latch(es) 80 from the latch receiver(s) 82 before beginning the (e.g., counterclockwise) turn. Once in the opened position, the cover 54 may be separated from the base.

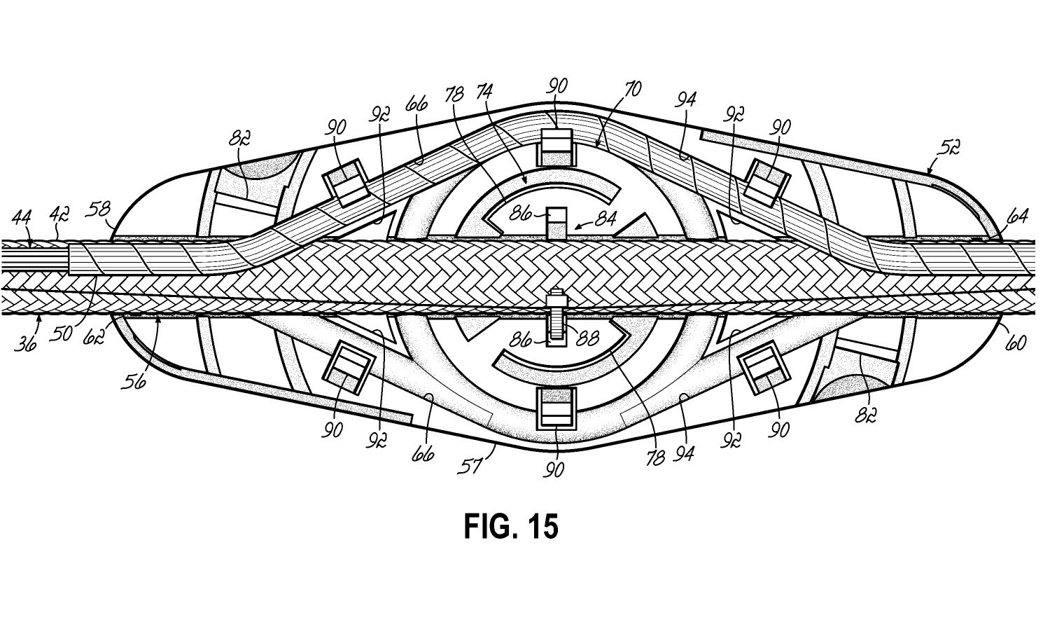

Referring now to FIG. 15, the Figure illustrates a drop leg cable 44 arranged in an alternative bend path 94. As explained above, the bend limiter 40 may be used to temporarily reroute a drop leg cable 44 to an alternative equipment rack 32 during installation of a data center 10, for example, if the equipment rack 32 that the drop leg cable 44 is intended for is unavailable. It is often the case that during the course of installation or afterwards, the previously unavailable equipment rack 32 becomes available. In such a circumstance, a technician may desire to re-reroute the drop leg cable 44 to the equipment rack 32 that the drop leg cable 44 was originally intended. The bend limiter 40 allows for this possibly.

More particularly, the bend limiter 40 allows for this possibility without requiring a technician to remove the bend limiter 40 from the distribution fiber optic cable 36. As shown in FIG. 15, the technician may simply place the drop leg cable 44 into the alternative bend path 94 instead of the bend path 66. The features of the alternative bend path 94 are much the same as the features of the bend path 66 described above. However, the alternative bend path 94 returns the drop leg cable 44 to the opposing opening of the central passage 56, instead of the same opening of the central passage 56. For example, if the drop leg cable 44 enters the central passage 56 through the first opening 62, the alternative bend path 94 will guide the drop leg cable 44 to exit the bend limiter 40 through the second opening 64. It should be understood that a technician could alternatively choose to route the drop leg cable 44 through the central passage 56 (i.e., with the distribution fiber optic cable 36) instead of utilizing the alternative bend path 94.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable assembly for installation in a fiber optic network, comprising:
a fiber optic cable carrying a plurality of optical fibers; and
at least one bend limiter connected to the fiber optic cable, wherein the at least one bend limiter comprises:
a base, comprising:
a base body;
a central passage extending along the base body, wherein at least a portion of the fiber optic cable is received in the central passage; and
a bend path operatively connected to the central passage, wherein a group of the plurality of optical fibers is received in the bend path, and wherein the bend path routes the group of optical fibers away from the central passage and then back to the central passage so that the group of optical fibers exits the bend limiter in an opposite direction from which the group of optical fibers enters the bend limiter; and
a cover releasably attached to the base to enclose a portion the fiber optic cable assembly and a portion of the group of optical fibers within the bend limiter.

2. The fiber optic cable assembly of claim 1, wherein the fiber optic cable includes a plurality of drop cables, and wherein the at least one bend limiter comprises a plurality of bend limiters each being positioned adjacent to one of the plurality of drop cables.

3. The fiber optic cable assembly of claim 1, wherein the at least one bend limiter is preinstalled on the fiber optic cable before installation of the fiber optic cable assembly in the fiber optic network.

4. The fiber optic cable assembly of claim 1, wherein the base body of the at least one bend limiter has a first end with a first opening and a second end with a second opening, wherein the central path extends between the first opening and the second opening, and wherein the bend path routes the group of optical fibers away from the central passage and then back to the central passage so that the group of optical fibers enters and exits the bend limiter at a same opening of the first opening or the second opening of the bend limiter.

5. The fiber optic cable assembly of claim 1, wherein for the at least one bend limiter, the group of optical fibers exits the central passage and enters into the bend path at a first longitudinal location along the bend path, and wherein the group of optical fibers exits the bend path and reenters the central passage at a second longitudinal location along the central passage, and wherein the first longitudinal location and the second longitudinal location are substantially the same.

6. The fiber optic cable assembly of claim 1, wherein the base of the at least one bend limiter further comprises at least one retention latch located along the bend path, and wherein the at least one retention latch releasably secures the group of optical fibers within the bend path.

7. The fiber optic cable assembly of claim 6, wherein the base of the at least one bend limiter further comprises at least one recessed surface arranged proximate to the at least one retention latch, and wherein the at least one recessed surface provides space for a user to press the group of optical fibers under the at least one retention latch.

8. The fiber optic cable assembly of claim 1, wherein the bend path of the at least one bend limiter includes a minimum bend radius, and wherein the minimum bend radius is at least 10 times a diameter of the group of optical fibers.

9. The fiber optic cable assembly of claim 1, wherein the cover of the at least one bend limiter is moveable relative to the base between an opened position and a closed position, and the bend limiter further includes a lock mechanism to resist movement of the cover away from the closed position.

10. The fiber optic cable assembly of claim 9, wherein the lock mechanism further comprises:
at least one security latch on one of the cover or base; and
at least one latch receiver on the other of the cover or base,
wherein the at least one security latch and the at least one latch receiver engage each other to resist movement of the cover away from the closed position.

11. The fiber optic cable assembly of claim 1, wherein the base of the at least one bend limiter further comprises an alternative bend path configured to route the group of optical fibers away from the central passage and then back to the central passage so that the group of optical fibers exits the bend limiter in a same direction from which the group of optical fibers entered the bend limiter.

12. A bend limiter for a fiber optic cable carrying a plurality of optical fibers, comprising:
a base, comprising:
a base body;
a central passage extending along the base body, the central passage configured to receive at least a portion of the fiber optic cable therein; and
a bend path operatively connected to the central passage, the bend path configured to receive a group of the plurality of optical fibers therein,
wherein the bend path is configured to route the group of optical fibers away from the central passage and then back to the central passage so that the group of optical fibers exits the bend limiter in an opposite direction from which the group of optical fibers entered the bend limiter; and
a cover releasably attachable to the base and configured to enclose a portion the fiber optic cable assembly and a portion of the group of optical fibers within the bend limiter.

13. The bend limiter of claim 12, wherein the base further comprises at least one retention latch located along the bend path, and wherein the at least one retention latch is configured to releasably secure the group of optical fibers within the bend path.

14. The bend limiter of claim 13, wherein the base further comprises at least one recessed surface arranged proximate to the at least one retention latch, and wherein the at least one recessed surface is configured to provide space for a user to press the group of optical fibers under the at least one retention latch.

15. A method of installing a fiber optic cable in a fiber optic network, the fiber optic cable carrying a plurality of optical fibers, the method comprising:
providing a bend limiter including a base and a cover, the base comprising a central passage and a bend path operatively connected to the central passage,
inserting the fiber optic cable in the central passageway of the base of the bend limiter;
inserting a group of the plurality of optical fibers along the bend path in the base of the bend limiter such that the group of optical fibers is routed away from the central passage and then back to the central passage so that the group of optical fibers exits the bend limiter in the same direction from which the group of optical fibers entered the bend limiter.

16. The method of claim 15, wherein the base further comprises at least one retention latch located along the bend path, and wherein the method further comprises releasably retaining the group of optical fibers within the bend path using the at least one retention latch.

17. The method of claim 15, wherein the cover is moveable relative to the base between an opened position and a closed position, and wherein the method further comprises engaging a lock mechanism to resist movement of the cover away from the closed position.

18. The method of claim 15, further comprising:
routing the group of optical fibers exiting the bend limiter to an upstream equipment rack; and
connecting terminated ends of the group of optical fibers to network equipment in the upstream equipment rack.

19. The method of claim 18, wherein the base of the bend limiter comprises an alternative bend path, and wherein the method further comprises:
removing the group of optical fibers from the bend path in the base of the bend limiter; and
inserting the group of optical fibers in the alternative bend path such that the group of optical fibers is routed away from the central passage and then back to the central passage so that the group of optical fibers exits the bend limiter in a same direction from which the group of optical fibers entered the bend limiter.

20. The method of claim 19, further comprising:
routing the group of optical fibers exiting the bend limiter to another equipment rack; and
connecting the terminated ends of the group of optical fibers to network equipment in the another equipment rack.
